(19) United States
(12) Patent Application Publication
(10) Pub. No.: US 2016/0036666 A1
(43) Pub. Date: Feb. 4, 2016

(54) INFORMATION SHARING SYSTEM, INFORMATION PROCESSING APPARATUS, AND INFORMATION TERMINAL

(71) Applicant: Osamu OGAWARA, Kanagawa (JP)

(72) Inventor: Osamu OGAWARA, Kanagawa (JP)

(21) Appl. No.: 14/800,140

(22) Filed: Jul. 15, 2015

(30) Foreign Application Priority Data
Jul. 30, 2014 (JP) 2014-154665

(51) Int. Cl. H04L 12/26

(52) U.S. Cl. CPC H04L 43/065; H04L 43/0811

(57) ABSTRACT

An information sharing system includes a first information terminal, an information processing apparatus capable of displaying an image providable from the first information terminal, and a second information terminal. The information processing apparatus includes a shutdown detector to detect a shutdown of data communication between the information processing apparatus and the first information terminal, and a reporting unit to report the shutdown of the data communication between the information processing apparatus and the first information terminal to the second information terminal when the shutdown detector detects the shutdown of the data communication. The first information terminal includes a shutdown detector to detect a shutdown of the data communication between the first information terminal and the information processing apparatus, and a reporting unit to report the shutdown of the data communication between the first information terminal and the information processing apparatus to the second information terminal.

### CROSS-REFERENCE TO RELATED APPLICATION

This application claims priority pursuant to 35 U.S.C. §119(a) to Japanese Patent Application No. 2014-154665, filed on Jul. 30, 2014 in the Japan Patent Office, the disclosure of which are incorporated by reference herein in their entirety.

### BACKGROUND

1. Technical Field

The present invention relates to an information sharing system displaying the same image at a plurality of sites, and more particularly to an information sharing system, an information processing apparatus, an information terminal, a method, and a storage medium of program that reports a reason or situation when a supply of sharing image is stopped.

2. Background Art

Electronic information boards are used at various organizations such as companies, schools, and government agencies when conferences or meetings are held.

The electronic information boards can display an image provided from an image providing unit such as a user personal computer (PC), and can superimpose other image on the displayed image. The electronic information board and the user PC can be configured as an image sharing system, in which images provided from the image providing unit (user PC) can be transmitted other user PCs disposed at a plurality of sites via a network, and the same images can be displayed at the plurality of sites.

When malfunctions occur to the electronic information board, the image providing unit (user PC) or the network connecting the electronic information board and the image providing unit (user PC), a supply of sharing image is stopped, in which the electronic information board transmits an end message to the image providing unit (user PC), and then the image providing unit (user PC) ends an application, but other users at other sites cannot comprehend the reason of supply stop of the sharing image.

### SUMMARY

In one aspect of the present invention, an information sharing system is devised. The information sharing system includes a first information terminal useable as an image providing unit, an information processing apparatus capable of displaying an image providable from the first information terminal, and a second information terminal capable of displaying an image receivable from the information processing apparatus. The first information terminal, the information processing apparatus, and the second information terminal are connectable one to another for communication. The information processing apparatus includes a shutdown detector to detect a shutdown of data communication between the information processing apparatus and the first information terminal, and a reporting unit to report the shutdown of the data communication between the information processing apparatus and the first information terminal to the second information terminal when the shutdown detector detects the shutdown of the data communication between the information processing apparatus and the first information terminal. The first information terminal includes a shutdown detector to detect a shutdown of the data communication between the first information terminal and the information processing apparatus, and a reporting unit to report the shutdown of the data communication between the first information terminal and the information processing apparatus to the second information terminal when the data communication between the first information terminal and the information processing apparatus is shutdown.

In another aspect of the present invention, an information processing apparatus capable of displaying an image providable from a first information terminal is devised. The first information terminal and the information processing apparatus are connectable with each other for communication. The information processing apparatus includes a shutdown detector to detect a shutdown of data communication between the information processing apparatus and the first information terminal, and a reporting unit to report the shutdown of the data communication between the information processing apparatus and the first information terminal to a second information terminal, connectable to the first information terminal and the information processing apparatus, when the shutdown detector detects the shutdown of the data communication between the information processing apparatus and the first information terminal.

In another aspect of the present invention, an information terminal capable of providing an image to an information processing apparatus is devised. The information terminal and the information processing apparatus are connectable with each other for communication. The information terminal includes a shutdown detector to detect a shutdown of the data communication between the information terminal and the information processing apparatus, and a reporting unit to report the shutdown of the data communication between the information terminal and the information processing apparatus to other information terminal, connectable to the information terminal and the information processing apparatus, when the shutdown detector detects the shutdown of the data communication between the information terminal and the information processing apparatus.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a schematic configuration of an image sharing system according to one or more example embodiments;

FIG. 2 is a schematic hardware configuration of an electronic information board employed for the image sharing system;

FIG. 3 is a schematic hardware configuration of a user PC employed for the image sharing system;

FIG. 4A is a functional configuration of the electronic information board;

FIG. 4B is a functional configuration of the user PC;

FIG. 5 is a sequential chart of a process performable by the image sharing system;

FIG. 6 is a flowchart showing the steps of a process performable by the electronic information board;

FIG. 7 is a flowchart showing the steps of a process performable by the electronic information board; and

FIG. 8 is a flowchart showing the steps of a process performable by a user PC used as an image providing unit.

The accompanying drawings are intended to depict exemplary embodiments of the present invention and should not be interpreted to limit the scope thereof. The accompanying drawings are not to be considered as drawn to scale unless explicitly noted, and identical or similar reference numerals designate identical or similar components throughout the several views.

### DETAILED DESCRIPTION

A description is now given of exemplary embodiments of the present invention. It should be noted that although such terms as first, second, etc. may be used herein to describe various elements, components, regions, layers and/or sections, it should be understood that such elements, components, regions, layers and/or sections are not limited thereby because such terms are relative, that is, used only to distinguish one element, component, region, layer or section from another region, layer or section. Thus, for example, a first element, component, region, layer or section discussed below could be termed a second element, component, region, layer or section without departing from the teachings of the present invention.

In addition, it should be noted that the terminology used herein is for the purpose of describing particular embodiments only and is not intended to be limiting of the present invention. Thus, for example, as used herein, the singular forms “a”, “an” and “the” are intended to include the plural forms as well, unless the context clearly indicates otherwise. Moreover, the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Furthermore, although in describing views shown in the drawings, specific terminology is employed for the sake of clarity, the present disclosure is not limited to the specific terminology so selected and it is to be understood that each specific element includes all technical equivalents that operate in a similar manner and achieve a similar result. Referring now to the drawings, one or more apparatuses or systems according to one or more example embodiments are described hereinafter.

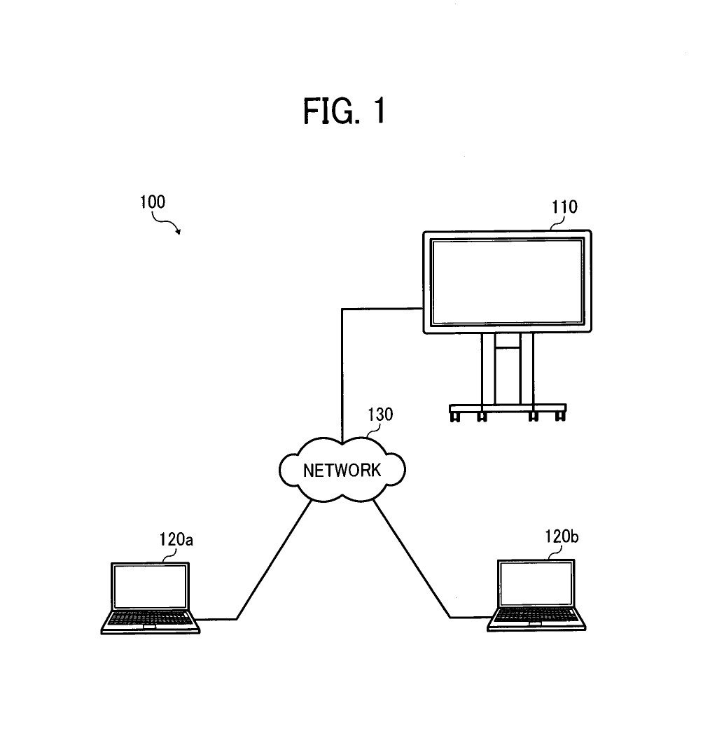

FIG. 1 is a schematic configuration of an image sharing system 100 according to one or more example embodiments. The image sharing system 100 is described as one example of information sharing systems. The image sharing system 100 includes, for example, an electronic information board 110, and user PCs 120a and 120b connectable with one another via a network 130. The network 130 can be configured with various networks such as the Internet, wireless local area network (LAN), and wired LAN. In a case of FIG. 1, the two user PCs 120a and 120b are connected to the network 130, but the network 130 can be connected with any number of user PCs.

The electronic information board 110 is an example of information processing apparatuses that can display various images such as still image and movie image. The electronic information board 110 performs data communication with the user PCs 120a and 120b, which can be used as an image providing unit, via the network 130. Upon receiving a sharing image from one user PC (120a used as the image providing unit, the electronic information board 110 displays the received image, and transmits the received image to other user PC (120b).

Each of the user PCs 120a and 120b is an example of information terminals that can communicate data with the electronic information board 110 and other user PCs via the network 130. When the user PCs 120a and 120b are used as the image providing unit, various images such as drawn-image drawn on a display unit of the user PC by a user and images displayed on the display unit can be provided to the electronic information board 110. Further, when the user PCs 120a and 120b are used as an image supplying destination, images supplied from the electronic information board 110 can be displayed on the display unit of the users 120a and 120b.

In a case of FIG. 1, each of the user PCs 120a and 120b employs a note personal computer (PC) as the information terminal, but other various information terminals such as smart phones, tablet PCs or the like can be employed.

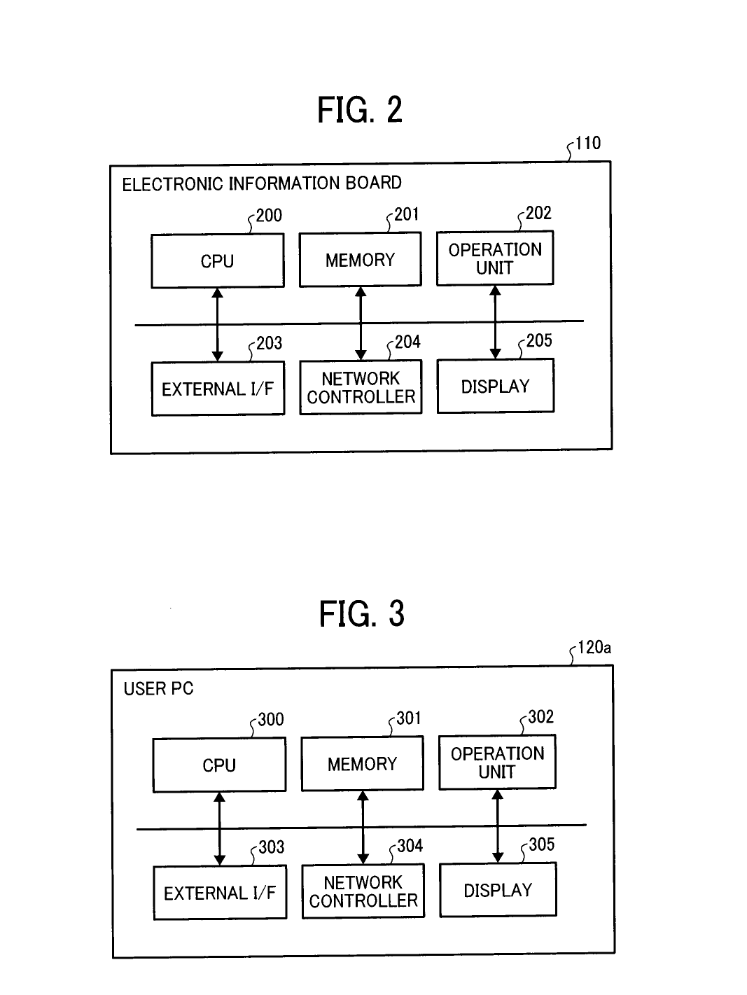

FIG. 2 is a schematic hardware configuration of the electronic information board 110. The electronic information board 110 includes, for example, a central processing unit (CPU) 200, a memory 201, an operation unit 202, an external interface (I/F) 203, a network controller 204, and a display 205.

The CPU 200 is a computing unit such as a processor or a circuit that executes software programs according to one or more example embodiments according to one or more example embodiments. The memory 201 is a storage medium that stores data such as software programs according to one or more example embodiments, which can be configured with a read only memory (ROM), a random access memory (RAM), a hard disk drive (HDD) or the like. Under a control of various operating systems (OS), the CPU 200 reads the software programs from the HDD and loads and executes the software programs on the RAM to perform functions to be described later for the electronic information board 110.

The operation unit 202 is used to receive instructions from a user. For example, a touch panel can be employed for the operation unit 202. The external I/F 203 is an interface connectable with various external apparatuses. The network controller 204 controls communication via the network 130. The display 205 is a display unit that displays various images. The display 205 can be a liquid crystal display, an organic electroluminescence (EL) display or the like.

FIG. 3 is a schematic hardware configuration of the user PC 120a. The user PC 120a includes, for example, a central processing unit (CPU) 300, a memory 301, an operation unit 302, an external interface (I/F) 303, a network controller 304, the display 305.

The CPU 300 is a computing unit such as a processor or a circuit that executes software programs according to one or more example embodiments. The memory 201 is a storage medium that stores data such as software programs according to one or more example embodiments, which can be configured with a read only memory (ROM), a random access memory (RAM), a hard disk drive (HDD) or the like. Under a control of various operating systems (OS). The CPU 300 reads the software programs from the HDD and loads and executes the software programs on the RAM to perform functions to be described later for the user PC 120.

The operation unit 302 is used to receive instructions from a user. For example, a key board and/or a touch panel can be employed for the operation unit 302. The external I/F 303 is an interface connectable with various external apparatuses such as a mouse and a key board. The network controller 304 controls communication via the network 130. The display 305 is a display unit that displays various images. The display 305 can be a liquid crystal display, an organic electroluminescence (EL) display or the like.

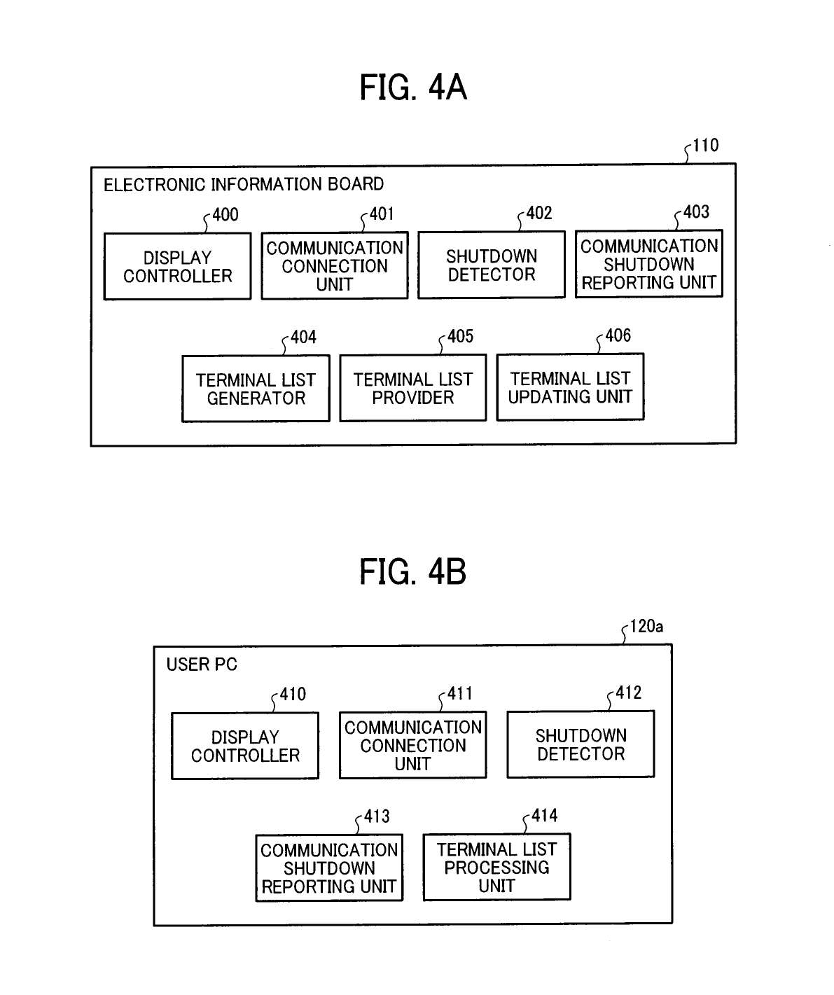

FIG. 4 is schematic functional configurations of the electronic information board 110 and the user PC 120a. A description is given of functional configuration of the electronic information board 110 and the user PC 120a with reference to FIGS. 4A and 4B. Since the functional configuration of the user PC 120b is same as the user PC 120a, the description of the user PC 120b is omitted.

As illustrated in FIG. 4A,the electronic information board 110 includes, for example, a display controller 400, a communication connection unit 401, a shutdown detector 402, a communication shutdown reporting unit 403, a terminal list generator 404, a terminal list provider 405, and a terminal list updating unit 406. The display controller 400 controls the display 205. Specifically, the display controller 400 controls the display 205 to display connection information (e.g., password) required for connecting with the electronic information board 110, and various images such as sharing images providable from a user PC used as the image providing unit and/or drawn-images drawn on the electronic information board 110.

The communication connection unit 401 establishes a communication connection with the user PCs 120a and 120b. The shutdown detector 402 detects a shutdown of communication between the electronic information board 110 and the user PC such as the user PCs 120a and 120b.

The communication shutdown reporting unit 403 reports a shutdown of communication between the electronic information board 110 and the user PC used as the image providing unit. Specifically, the communication shutdown reporting unit 403 reports a shutdown of communication between the electronic information board 110 and the user PC, used as the image providing unit, to other one or more user PCs not used as the image providing unit.

The terminal list generator 404, used as a terminal information generator, updates information of a terminal list of user PCs that establish communication with the electronic information board 110. The terminal list is used as an example of terminal information in this description. For example, the terminal list registers identification (ID) information of user PCs such as the Internet protocol (IP) addresses that establish communication with the electronic information board 110.

The terminal list provider 405 provides the terminal list to the user PCs 120a and 120b that establish communication with the electronic information board 110. For example, the terminal list provider 405 provides the terminal list to the user PC that establish communication with the electronic information board 110 when the terminal list is generated or updated.

The terminal list updating unit 406, used as a terminal information updating unit, updates the terminal list. Specifically, the terminal list updating unit 406 updates the terminal list when the connection of the electronic information board 110 with the user PCs 120a and 120b ends.

As illustrated in FIG. 4B, the user PC 120a includes, for example, a display controller 410, a communication connection unit 411, a shutdown detector 412, a communication shutdown reporting unit 413, and a terminal list processing unit 414.

The display controller 410 controls the display 305 to display various images. Specifically, the display controller 410 controls the display 305 to display various images such as images providable by applications installed in the user PC 120a and images drawn on the electronic information board 110.

The communication connection unit 411 establishes a communication connection with the electronic information board 110. Specifically, the communication connection unit 411 broadcasts a response request to the network 130, and transmits connection information and a connection request to the electronic information board 110 that returns a return response to the response request to establish a communication connection with the electronic information board 110.

The shutdown detector 412 detects a shutdown of communication between the user PC 120a and the electronic information board 110. The communication shutdown reporting unit 413 reports a shutdown of communication between the user PC 120a and the electronic information board 110. For example, the communication shutdown reporting unit 413 reports a shutdown of communication between the electronic information board 110 and the user PC 120a (first information terminal) to other user PC (second information terminals) that establishes communication with the electronic information board 110.

The terminal list processing unit 414 processes the terminal list providable from the electronic information board 110. Upon receiving the terminal list from the electronic information board 110, the terminal list processing unit 414 stores the terminal list in the memory 301.

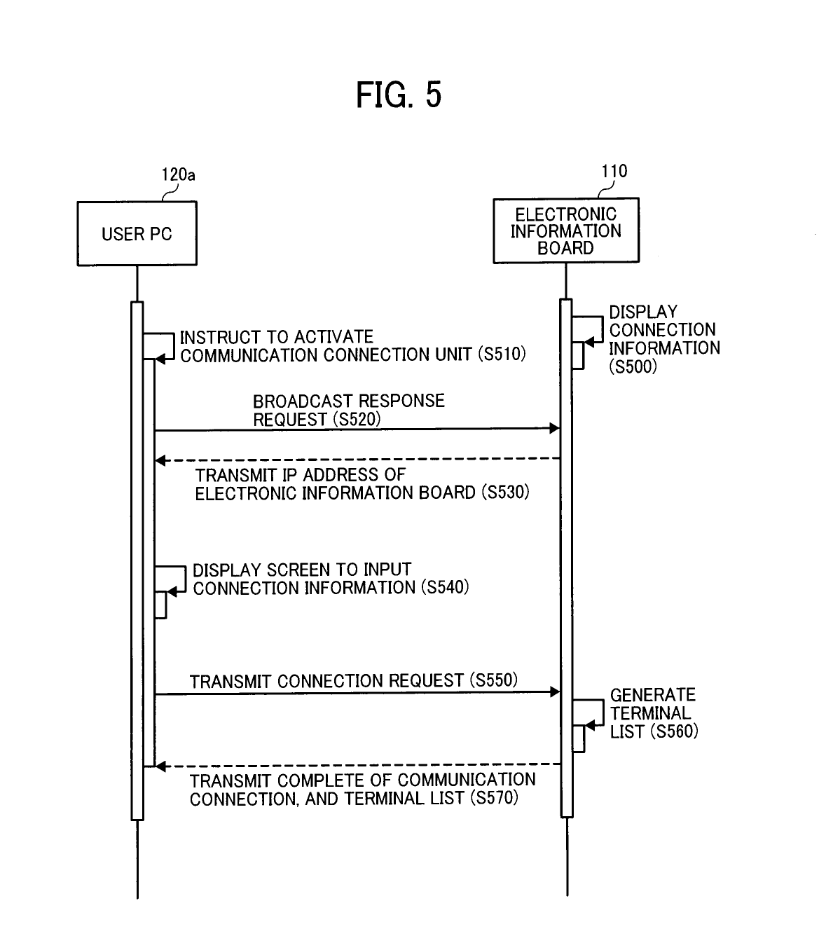

FIG. 5 is a sequential chart of processing performable by the image sharing system 100. A description is given of a process of establishing a communication connection between the user PC 120a and the electronic information board 110 with reference to FIG. 5.

When a user instructs the electronic information board 110 to display connection information, the display controller 400 displays the connection information required for a communication connection with the electronic information board 110 on the display 205 (S500). Further, when the user instructs the user PC 120a to activate the communication connection unit 401 (S510), the user PC 120a activates the communication connection unit 401, and the communication connection unit 401 broadcasts a response request (S520) to the electronic information board 110.

Upon receiving the response request from the user PC 120a, the communication connection unit 401 of the electronic information board 110 transmits an IP address of the electronic information board 110 to the user PC 120a (S530) as a return response to the response request received from the user PC 120a.

Upon receiving the return response from the electronic information board 110, the display controller 410 of the user PC 120a generates and displays a screen image used for inputting connection information (S540). When the user inputs the connection information into the screen image, the communication connection unit 411 transmits a connection request and the connection information to the electronic information board 110 (S550).

Upon receiving the connection request from the user PC 120a, the communication connection unit 401 of the electronic information board 110 establishes a communication connection with the user PC 120a. Then, the terminal list generator 404 generates a terminal list (S560) by registering the IP address of the user PC 120a, and the terminal list provider 405 transmits the terminal list to the user PC 120a with a notice indicating the communication connection is successfully completed (S570).

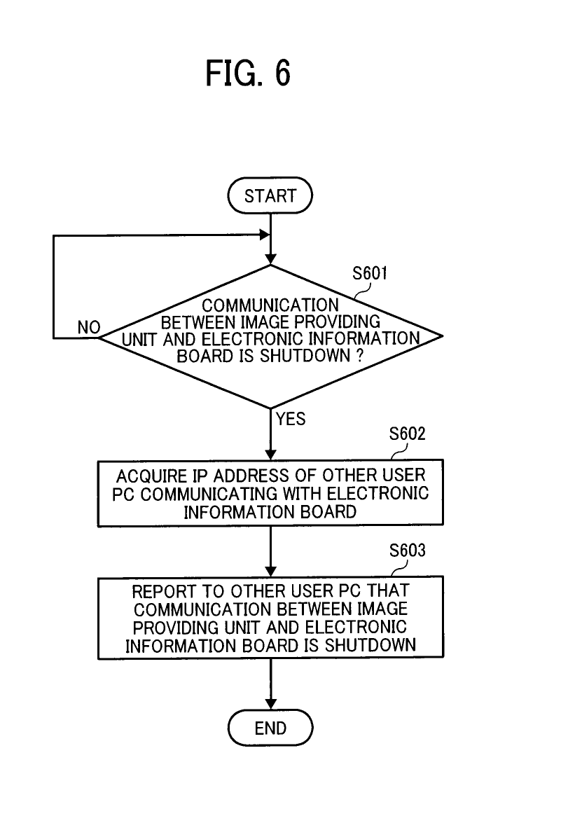

FIG. 6 is a flowchart showing the steps performable by the electronic information board 110 according to one or more example embodiments. A description is given of a process after the electronic information board 110 establishes communication with the user PC such as the image providing unit with reference to FIG. 6.

At step S601, the shutdown detector 402 of the electronic information board 110 determines whether data communication between the user PC 120a, used as the image providing unit, and the electronic information board 110 is shutdown.

As to the above described configuration, when the electronic information board 110 does not receive image data from the user PC 120a, used as the image providing unit, for a given time period or more (i.e., given time elapses), the shutdown detector 402 determines that the data communication with the user PC 120a is shutdown.

In other configuration, the electronic information board 110 can conduct polling to the user PC, used as the image providing, and the shutdown detector 402 can determine whether data communication between the user PC 120a and the electronic information board 110 is shutdown depending on whether a response to the polling is received or not.

If the data communication with the user PC 120a is not shutdown (S601: NO), the sequence repeats step S601. By contrast, if the data communication with the user PC 120a is shutdown (S601: YES), the sequence proceeds to step S602.

At step S602, the communication shutdown reporting unit 403 refers the terminal list stored in the memory 301, and acquires an IP address of other user PC, not used as the image providing unit but communicating with the electronic information board 110.

At step S603, the communication shutdown reporting unit 403 reports to the other user PC, not used as the image providing unit, that the data communication between the user PC 120a, used as the image providing unit, and the electronic information board 110 is shutdown, and then the sequence ends. The other user PC, which receives a reporting notice, displays the reporting notice on a display unit of the other user PC.

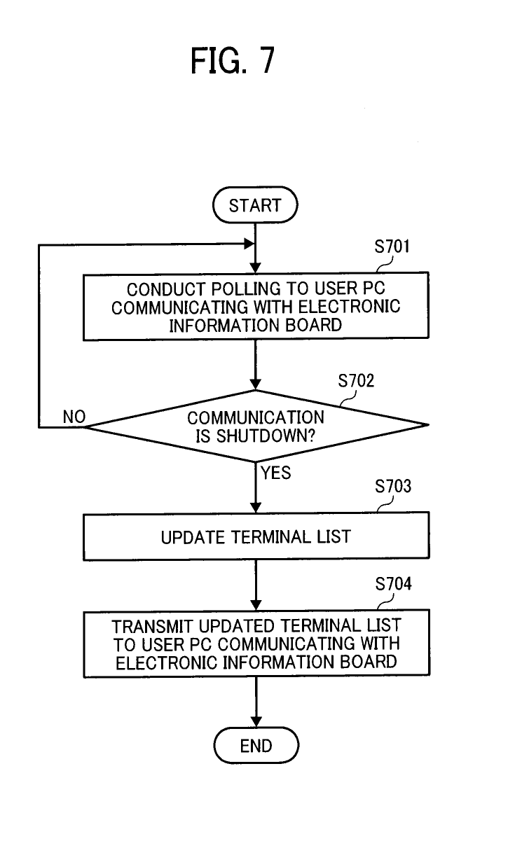

FIG. 7 is a flowchart showing the steps of a process performable by the electronic information board 110 according to one or more example embodiments. A description is given of a process after the electronic information board 110 establishes communication with one user PC with reference to FIG. 7.

At step S701, the shutdown detector 402 of the electronic information board 110 refers the terminal list stored in the memory 201, and performs or conducts polling to a user PC (second information terminal) establishing a connection with the electronic information board 110, in which the user PC (second information terminal) is not used as the image providing unit (first information terminal).

At step S702, the shutdown detector 402 determines whether communication with the user PC (second information terminal) is shutdown depending on whether a response to the polling is received or not from the user PC. If the communication is not shutdown (S702: NO), the sequence returns to step S701. By contrast, if the communication is shutdown (S702: YES), the sequence proceeds to step S703.

At step S703, the terminal list updating unit 406 updates the terminal list. Specifically, the terminal list updating unit 406 updates the terminal list by deleting the IP address of the user PC (second information terminal) having shutdown the communication with the electronic information board 110 from the terminal list.

At step S704, the terminal list provider 405 refers the terminal list to identify a user PC (first information terminal) being in communication with the electronic information board 110, and transmits the updated terminal list to the user PC (first information terminal) being in communication with the electronic information board 110, and the sequence ends.

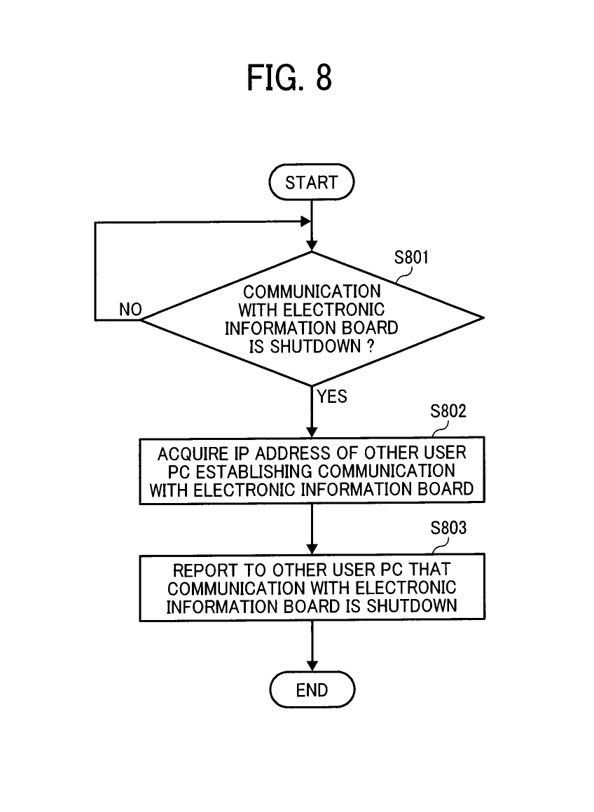

FIG. 8 is a flowchart showing the steps a process performable by a user PC (first information terminal) used as the image providing unit according to one or more example embodiments. A description is given of a process performable by the user PC 120a, used as the image providing unit, when the electronic information board 110 shutdowns a communication with the user PC 120a ((first information terminal) with reference to FIG. 8.

At step S801, the shutdown detector 412 of the user PC 120a determines whether data communication between the user PC 120a, used as the image providing unit, and the electronic information board 110 is shutdown.

As to the example embodiment, when the user PC 120a transmits a sharing image to the electronic information board 110 and the user PC 120a does not receive a return response from the electronic information board 110 for the transmitted sharing image for a given time period or more (i.e., given time elapses), the shutdown detector 412 of the user PC 120a determines that the data communication with the electronic information board 110 is shutdown.

If the data communication with the electronic information board 110 is not shutdown (S801: NO), the sequence repeats step S801. By contrast, the data communication with the electronic information board 110 is shutdown (S801: YES), the sequence proceeds to step S802.

At step S802, the communication shutdown reporting unit 413 of the user PC 120a refers the terminal list stored in the memory 301, and acquires an IP address of other user PC (second information terminal or other information terminal) establishing the communication connection with the electronic information board 110.

At step S803, the communication shutdown reporting unit 413 of the user PC 120a (first information terminal) reports to the other user PC establishing the communication connection with the electronic information board 110 that the data communication between the user PC 120a (first information terminal) and the electronic information board 110 is shutdown via the network 130, and the sequence ends. The other user PC, which receives the reporting notice, displays the reporting notice on a display unit of the other user PC.

As to the above described one or more example embodiments, a method of processing information performable by an information processing apparatus capable of displaying an image providable from a first information terminal can be devised. The information processing apparatus and the first information terminal are connectable with each other for communication. The method includes the steps of detecting a shutdown of data communication between the information processing apparatus and the first information terminal, and reporting the shutdown of the data communication between the information processing apparatus and the first information terminal to a second information terminal connectable to the first information terminal and the information processing apparatus when the detecting step detects the shutdown of the data communication between the information processing apparatus and the first information terminal. The second information terminal is capable of displaying an image providable from the information processing apparatus.

The above method further includes the steps of generating terminal information identifying the second information terminal having established a connection with the information processing apparatus, and the reporting step reports the shutdown of the data communication between the information processing apparatus and the first information terminal to the second information terminal identifiable by the terminal information.

The above method further includes the steps of updating the terminal information when a connection of the information processing apparatus with the second information terminal is ended, and the reporting step reports the shutdown of the data communication between the information processing apparatus and the first information terminal to the second information terminal identifiable by the updated terminal information.

Further, another method of processing information performable by an information terminal capable of providing an image to an information processing apparatus can be devised. The information terminal and the information processing apparatus are connectable with each other for communication. The another method includes the steps of detecting a shutdown of the data communication between the information terminal and the information processing apparatus, and reporting the shutdown of the data communication between the information terminal and the information processing apparatus to other information terminal, connectable to the information terminal and the information processing apparatus, when the detecting step detects the shutdown of the data communication between the information terminal and the information processing apparatus.

In the above another method, the reporting step reports the shutdown of the data communication between the information terminal and the information processing apparatus to the other information terminal identifiable by terminal information providable from the information processing apparatus.

Further, a non-transitory storage medium storing a program that, when executed by a computer, causes the computer to execute a method of processing information performable by an information processing apparatus capable of displaying an image providable from a first information terminal, and a second information terminal capable of displaying an image receivable from the information processing apparatus can be devised. The information processing apparatus, the first information terminal, and the second information terminal are connectable one to another for communication. The method includes the steps of detecting a shutdown of data communication between the information processing apparatus and the first information terminal, and reporting the shutdown of the data communication between the information processing apparatus and the first information terminal to the second information terminal when the detecting step detects the shutdown of the data communication between the information processing apparatus and the first information terminal. The second information terminal is capable of displaying an image providable from the information processing apparatus. Further, a non-transitory storage medium storing a program that, when executed by a computer, causes the computer to execute another method of processing information performable by an information terminal capable of providing an image to an information processing apparatus, and other information terminal capable of displaying an image receivable from the information processing apparatus can be devised. The information terminal, the information processing apparatus, and the other information terminal are connectable one to another for communication. The another method includes the steps of detecting a shutdown of the data communication between the information terminal and the information processing apparatus; and reporting the shutdown of the data communication between the information terminal and the information processing apparatus to other information terminal, connectable to the information terminal and the information processing apparatus, when the detecting step detects the shutdown of the data communication between the information terminal and the information processing apparatus.

As to the above described information sharing system such as an image sharing system, information processing apparatus, information terminal, method, and software program, when a supply of sharing image is stopped, the information sharing system that shares displaying of images at a plurality of sites can report a reason or situation of the supply stop to users located at a plurality of sites.

The present invention can be implemented in any convenient form, for example using dedicated hardware platform, or a mixture of dedicated hardware platform and software. Each of the functions of the described embodiments may be implemented by one or more processing circuits or circuitry. Processing circuitry includes a programmed processor, as a processor includes circuitry. A processing circuit also includes devices such as an application specific integrated circuit (ASIC) and conventional circuit components arranged to perform the recited functions. The illustrated server apparatuses are only illustrative of one of several computing environments for implementing the embodiments disclosed herein. For example, in some embodiments, any one of the information processing apparatus may include a plurality of computing devices, e.g., a server cluster, that are configured to communicate with each other over any type of communication links, including a network, a shared memory, etc. to collectively perform the processes disclosed herein.

The computer software can be provided to the programmable device using any storage medium or carrier medium such as non-volatile memory for storing processor-readable code such as a floppy disk, a flexible disk, a compact disk read only memory (CD-ROM), a compact disk rewritable (CD-RW), a digital versatile disk read only memory (DVD-ROM), DVD recording only/rewritable (DVD-R/RW), electrically erasable and programmable read only memory (EEPROM), erasable programmable read only memory (EPROM), a memory card or stick such as USB memory, a memory chip, a mini disk (MD), a magneto optical disc (MO), magnetic tape, a hard disk in a server, a flash memory, Blu-ray disc (registered trademark), SD card, a solid state memory device or the like, but not limited these. Further, the computer software can be provided through communication lines such as electrical communication line. Further, the computer software can be provided in a read only memory (ROM) disposed for the computer. The computer software stored in the storage medium can be installed to the computer and executed to implement the above described processing. The computer software stored in the storage medium or apparatus of an external apparatus can be downloaded and installed to the computer via a network to implement the above described processing.

The hardware platform includes any desired kind of hardware resources including, for example, a central processing unit (CPU), a random access memory (RAM), and a hard disk drive (HDD). The CPU may be implemented by any desired kind of any desired number of processors. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

In the above-described example embodiment, a computer can be used with a computer-readable program, described by object-oriented programming languages such as C, C++, C#, Java (registered trademark), JavaScript (registered trademark), Perl, Ruby, or legacy programming languages such as machine language, assembler language to control functional units used for the apparatus or system. For example, a particular computer (e.g., personal computer, workstation) may control an information processing apparatus or an image processing apparatus such as image forming apparatus using a computer-readable program, which can execute the above-described processes or steps.

In the above-described embodiments, at least one or more of the units of apparatus can be implemented as hardware or as a combination of hardware/software combination. Each of the functions of the described embodiments may be implemented by one or more processing circuits. A processing circuit includes a programmed processor, as a processor includes circuitry. A processing circuit also includes devices such as an application specific integrated circuit (ASIC) and conventional circuit components arranged to perform the recited functions.

Numerous additional modifications and variations for the communication terminal, information processing system, and information processing method, a program to execute the information processing method by a computer, and a storage or carrier medium of the program are possible in light of the above teachings. It is therefore to be understood that within the scope of the appended claims, the disclosure of the present invention may be practiced otherwise than as specifically described herein. For example, elements and/or features of different examples and illustrative embodiments may be combined each other and/or substituted for each other within the scope of this disclosure and appended claims.

What is claimed is:

1. An information sharing system comprising:
a first information terminal useable as an image providing unit;
an information processing apparatus capable of displaying an image providable from the first information terminal; and
a second information terminal capable of displaying an image receivable from the information processing apparatus, the first information terminal, the information processing apparatus, and the second information terminal connectable one to another for communication,
the information processing apparatus including:
a shutdown detector to detect a shutdown of data communication between the information processing apparatus and the first information terminal; and
a reporting unit to report the shutdown of the data communication between the information processing apparatus and the first information terminal to the second information terminal when the shutdown detector detects the shutdown of the data communication between the information processing apparatus and the first information terminal, and
the first information terminal including:
a shutdown detector to detect a shutdown of the data communication between the first information terminal and the information processing apparatus; and
a reporting unit to report the shutdown of the data communication between the first information terminal and the information processing apparatus to the second information terminal when the data communication between the first information terminal and the information processing apparatus is shutdown.

2. The information sharing system of claim 1, wherein the information processing apparatus further includes a terminal information generator to generate terminal information identifying the second information terminal having established a connection with the information processing apparatus, and
the reporting unit of the information processing apparatus reports the shutdown of the data communication between the information processing apparatus and the first information terminal to the second information terminal identifiable by the terminal information.

3. The information sharing system of claim 1, wherein the information processing apparatus further includes a terminal information generator to generate terminal information identifying the second information terminal having established a connection with the information processing apparatus, and a terminal information provider to provide the terminal information to the first information terminal, and
the reporting unit of the first information terminal reports the shutdown of the data communication between the first information terminal and the information processing apparatus to the second information terminal identifiable by the terminal information providable from the terminal information provider.

4. The information sharing system of claim 2, wherein the information processing apparatus further includes a terminal information updating unit to update the terminal information when a connection of the information processing apparatus with the second information terminal is ended, and
the reporting unit of the information processing apparatus reports the shutdown of the data communication between the information processing apparatus and the first information terminal to the second information terminal identifiable by the updated terminal information.

5. The information sharing system of claim 3, wherein the information processing apparatus further includes a terminal information updating unit to update the terminal information when a connection of the information processing apparatus with the second information terminal is ended,
the terminal information provider transmits the terminal information updated by the terminal information updating unit to the first information terminal, and
the reporting unit of the first information terminal reports the shutdown of the data communication between the first information terminal and the information processing apparatus to the second information terminal identifiable by the updated terminal information.

6. An information processing apparatus capable of displaying an image providable from a first information terminal, the information processing apparatus and the first information terminal connectable with each other for communication, the information processing apparatus comprising:
a shutdown detector to detect a shutdown of data communication between the information processing apparatus and the first information terminal; and
a reporting unit to report the shutdown of the data communication between the information processing apparatus and the first information terminal to a second information terminal, connectable to the first information terminal and the information processing apparatus, when the shutdown detector detects the shutdown of the data communication between the information processing apparatus and the first information terminal.

7. The information processing apparatus of claim 6, further comprising a terminal information generator to generate terminal information identifying the second information terminal having established a connection with the information processing apparatus, and
the reporting unit reports the shutdown of the data communication between the information processing apparatus and the first information terminal to the second information terminal identifiable by the terminal information.

8. The information processing apparatus of claim 7, further comprising a terminal information updating unit to update the terminal information when a connection of the information processing apparatus with the second information terminal is ended, and
the reporting unit reports the shutdown of the data communication between the information processing apparatus and the first information terminal to the second information terminal identifiable by the updated terminal information.

9. An information terminal capable of providing an image to an information processing apparatus, the information terminal and the information processing apparatus connectable with each other for communication, the information terminal comprising:
a shutdown detector to detect a shutdown of the data communication between the information terminal and the information processing apparatus; and
a reporting unit to report the shutdown of the data communication between the information terminal and the information processing apparatus to other information terminal, connectable to the information terminal and the information processing apparatus, when the shutdown detector detects the shutdown of the data communication between the information terminal and the information processing apparatus.

10. The information terminal of claim 9, wherein the reporting unit reports the shutdown of the data communication between the information terminal and the information processing apparatus to the other information terminal identifiable by terminal information providable from the information processing apparatus.
